(19) United States
(12) Patent Application Publication
(10) Pub. No.: US 2003/0196168 A1
(43) Pub. Date: Oct. 16, 2003

(54) Method and apparatus for modeling extensible markup language (XML) applications using the unified modeling language (UML)

(75) Inventor: Jingkun Hu, Danbury, CT (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/119,605

(22) Filed: Apr. 10, 2002

(51) Int. Cl. G06F 9/44; G06F 15/00

(52) U.S. Cl. 715/513; 717/104; 717/114

(57) ABSTRACT

A method and apparatus are disclosed for modeling XML applications using an extended UML notation. The present invention extends the UML model template to include an additional compartment, referred to as a constant attribute compartment. The constant attribute compartment allows the constant attributes of an XML element to be explicitly represented in the UML model. The disclosed UML model can thereby distinguish XML elements and XML attributes using the additional constant attribute compartment to represent attributes that remain constant through all instances of an object. The UML modeling of XML elements is more clear and readable by separately modeling the constant attributes and the variable attributes of the XML element. The present invention facilitates the automatic generation of XML schemas and source code with the appropriate software tools.

### FIELD OF THE INVENTION

The present invention relates to methods and apparatus for modeling XML applications, and more particularly, to methods and apparatus for modeling XML applications using a UML notation.

### BACKGROUND OF THE INVENTION

The Extensible Markup Language (XML), recommended by the World Wide Web Consortium (W3C), is a popular standard for encoding textual information. For a discussion of the XML standard, see, for example, Extensible Markup Language (XML) 1.0 W3C Recommendation, http://www.w3.org/TR/1998/REC-xml-19980210, incorporated by reference herein. The XML standard allows XML-enabled applications to inter-operate with other compliant systems for the exchange of encoded information.

As XML becomes more popular with information technology professionals, the ability to accurately model XML applications is becoming increasingly important. Currently, most XML applications are modeled using the Unified Modeling Language (UML), standardized by the Object Management Group (OMG), and described in www.omg.org/uml.

UML modeling is particularly desirable since the source code for an application that is modeled in accordance with the UML standard can be automatically generated in a number of common programming languages, such as Java and C++, using available UML tools. In addition, an XML Document Type Definition (DTD) can be generated from UML models using available XML Metadata Interchange (XMI) techniques.

FIG. 1 illustrates the current UML notation for modeling objects. As shown in FIG. 1, a class element is represented in UML using a unit 100 having three compartments 110, 120, 130. A class name compartment 110 records the name of the corresponding class. An attribute compartment 120 indicates one or more attribute names and their corresponding type. An operation compartment 130 indicates one or more operation names with their corresponding signatures.

The UML standard was originally developed to model object-oriented applications. The notation shown in FIG. 1 works well for the modeling of objects in object-oriented applications, where a class has a set of attributes and operations. With the increasing use of distributed computing, however, the constant attributes of a class, such as unique class identifier, are important for identifying such a class or instance of this class. A need therefore exists for an extension of the UML model that allows the constant attributes of a class to be explicitly indicated in the UML model. A further need exists for a method and apparatus that allows an XML document or application object to be more precisely expressed.

A number of techniques have been proposed or suggested for modeling XML applications with UML or variations of UML. For a discussion of conventional techniques for modeling XML applications with UML, see, for example, David Carlson, “Modeling XML Applications with UML—Practical e-Business Applications, Addison-Wesley (2001). XML data itself does not have behaviors or operations but only attributes and elements. Generally, the basic unit of XML data is an element. An element has a value or has its own attributes (or both). In the current UML notation, however, it is difficult to differentiate between XML elements and attributes because they are typically put in the attribute compartment 120.

### SUMMARY OF THE INVENTION

Generally, a method and apparatus are disclosed for modeling XML applications using an extended UML notation. The present invention extends the UML model template to include an additional compartment, referred to herein as a constant attribute compartment. The constant attribute compartment allows the constant attributes of an XML element to be explicitly represented in the UML model. In this manner, the disclosed UML model distinguishes XML elements and XML attributes using the additional constant attribute compartment to store attributes that generally remain constant through all instances of an XML element type.

The present invention makes the UML modeling of XML elements more clear and readable by separately modeling the attributes and elements of the XML element type. In addition, the present invention facilitates the automatic generation of XML schemas and source code with the appropriate software tools. An XML schema generator is disclosed that uses the extended UML model template of the present invention to automatically generate XML schemas. A source code generator is disclosed that uses the extended UML model template of the present invention to generate source code in a given programming language.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional unit for representing an object in accordance with the current UML model;

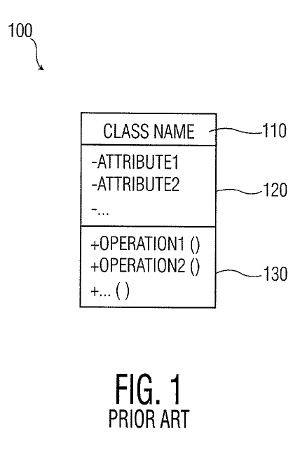

FIG. 2 illustrates a first conventional approach for modeling XML applications with UML or variations of UML;

FIG. 3 illustrates a second conventional approach for modeling XML applications with UML or variations of UML;

FIG. 4 illustrates a third conventional approach for modeling XML applications with UML or variations of UML;

FIG. 5 illustrates a new UML notation in accordance with the present invention for modeling XML elements;

FIG. 6 illustrates an XML schema generator that generates XML schemas using the UML model template of the present invention;

FIG. 7 illustrates a source code generator that generates source code a given programming language using the UML model template of the present invention; and

FIG. 8 is a block diagram of a system suitable for implementing all or a portion of the present invention.

### DETAILED DESCRIPTION

As discussed hereinafter, the present invention extends the UML model to allow the constant attributes of a class to be explicitly indicated in the UML model. Thus, the present invention provides methods and apparatus that allow XML documents or application objects to be more precisely expressed. In particular, the disclosed UML model distinguishes XML elements and XML attributes by inserting an additional constant attribute compartment for containing attributes that generally remain constant through all instances of an XML element type.

In UML, attributes are member/data variables of a class. These attributes can be divided into two categories: constant attributes such as class identification and variable attributes which vary from objects to objects. Here, attributes we mention are UML attributes not XML attributes.

### Modeling XML Applications With UML

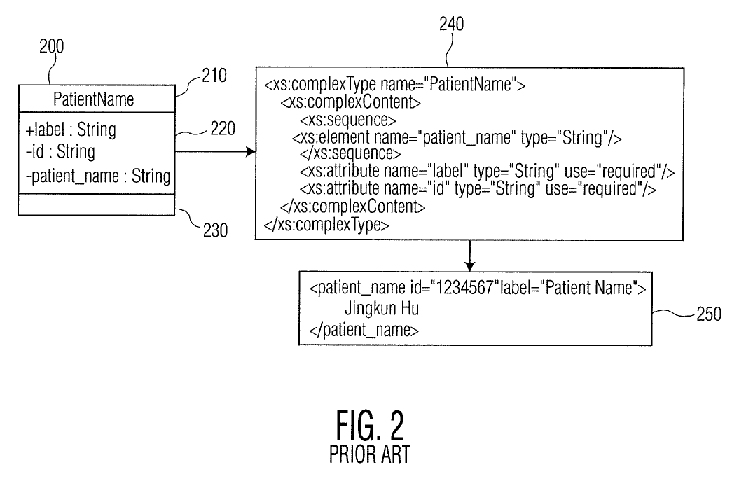

A number of techniques have been proposed or suggested for modeling XML applications with UML or variations of UML. FIG. 2 illustrates one conventional approach for modeling XML applications using UML. As shown in FIG. 2, the exemplary class name compartment 210 records the name of the corresponding class or element, PatientName. A label field and an id field in the attribute compartment 220 hold attributes of the element, PatientName. The field patient_name holds the value of the element, PatientName. As shown in FIG. 2, an XML schema 240 is manually generated from the UML class model 200. The operation compartment 230 is not used for modeling of XML objects. Finally, actual instances of the schema 250 can be generated using the XML schema 240.

The problem with the first approach shown in FIG. 2 is that the model itself does not indicate which fields in the attribute compartment 220 are mapped to XML elements or attributes.

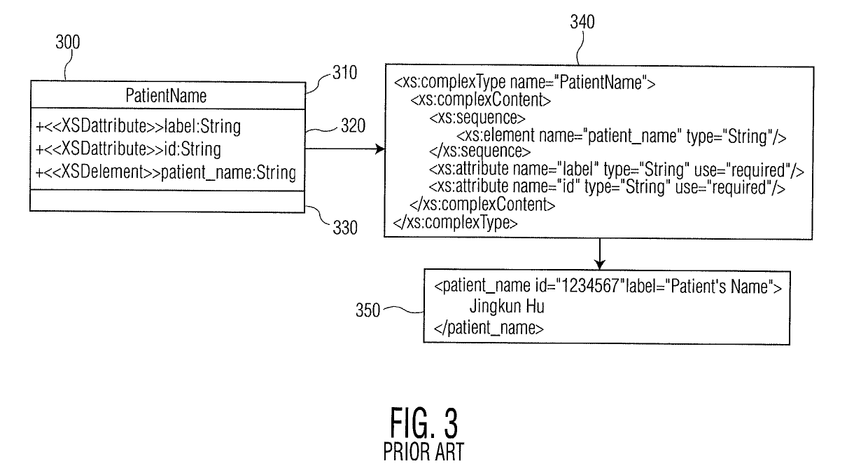

FIG. 3 illustrates another conventional approach for modeling XML applications using UML. As shown in FIG. 3, the exemplary class name compartment 310 records the name of the corresponding class or element, PatientName. A label field and an id field in the attribute compartment 320 hold attributes of the element, PatientName. The field patient_name holds the value of the element, PatientName. Unlike the first approach in FIG. 2, the label, id and patient_name fields are marked as being an attribute or an element. As shown in FIG. 3, an XML schema 340 is manually generated from the UML class model 300. The operation compartment 330 is not used for modeling of XML objects. Finally, actual instances of the schema 350 can be generated using the XML schema 340.

The problem with the second approach shown in FIG. 3 is that the model is too verbose and the mapping rules must be applied to each UML attribute to evaluate its target. The UML attribute usage cannot be specified.

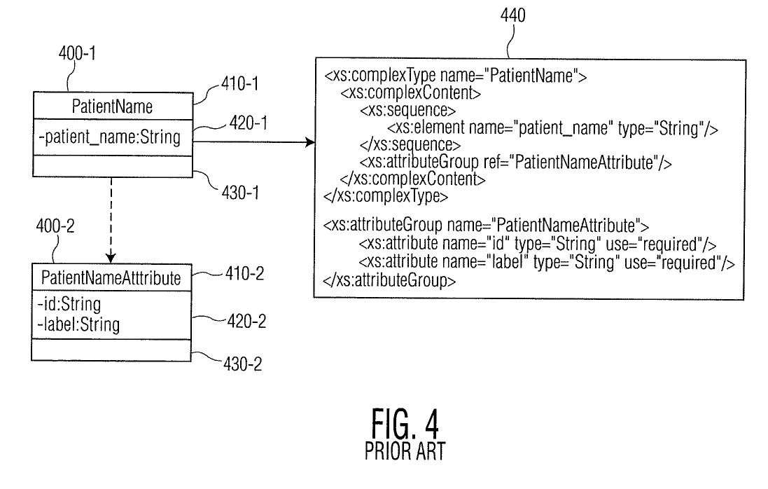

FIG. 4 illustrates yet another conventional approach for modeling XML applications using UML, where two UML units are used to represent each XML element. A first unit 400-1 holds the variable attribute information about the element and a second unit 400-2 holds the constant attribute information about the element. As shown in FIG. 4, the exemplary class name compartment 410-1 of a first unit 400-1 records the name of the corresponding class or element, PatientName. The field patient_name in the attribute compartment 420-1 holds the value of the element, PatientName.

A label field and an id field in the attribute compartment 420-2 of the second unit 400-2 hold the constant attributes of the element, PatientName. As shown in FIG. 4, an XML schema 440 can be automatically generated from the UML class model 400-1, 2. The operation compartment 430 is not used for modeling of XML objects. Actual instances of the schema (not shown) can be generated using the XML schema 440.

The problem with the third approach shown in FIG. 4 is that the model requires a separate, additional class to define the attributes.

### Extended UML for Modeling XML Applications

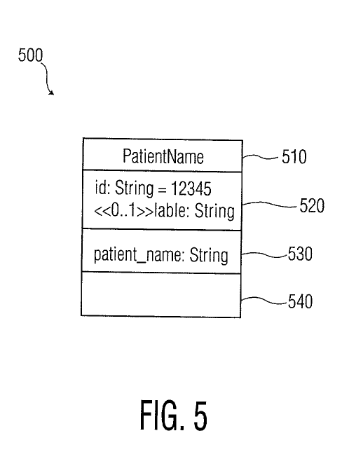

FIG. 5 illustrates a new UML notation in accordance with the present invention for modeling XML elements. As shown in FIG. 5, an XML element is represented using a UML unit 500 having four compartments 510, 520, 530, 540. A class name compartment 510 records the name of the corresponding class or XML element type. The class name compartment 510 allows a stereotype to be specified, such as simpleType and complexType in XML structures (see, for example, XML Schema Definition Language, www.w3c.org/XML/Schema).

A constant attribute compartment 520 specifies the constant attributes that will remain constant through all the PatientName instances. A variable attribute compartment 530 specifies the variable attributes that will vary for different PatientName instances. The operation compartment 540 indicates one or more operation names with their corresponding return type and parameters, and is typically empty in defining XML types. In compartment 520, <<0 . . 1>> specifies the usage of the attribute label as optional. Similarly, the usage of other attributes can also be specified. The numbers within the brackets “<< >>” specify the minimum and maximum occurrences of a given attributes.

### Applications of Extended UML Model

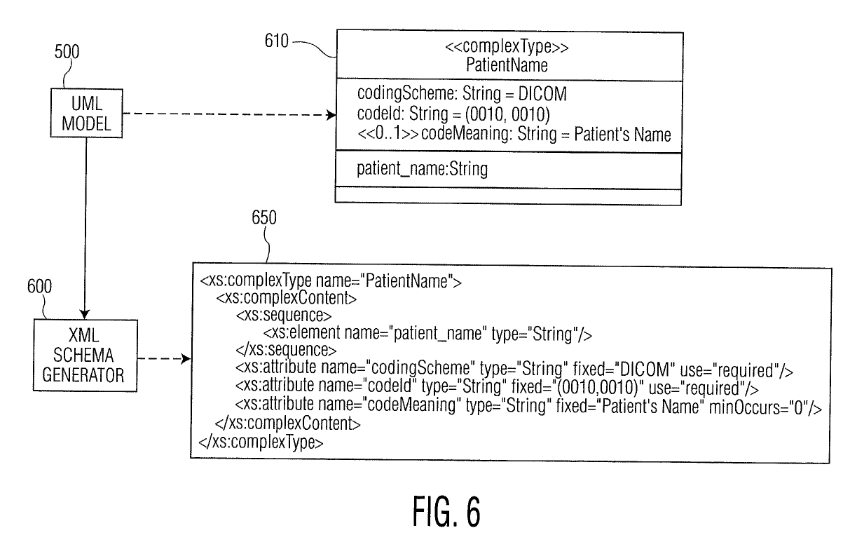

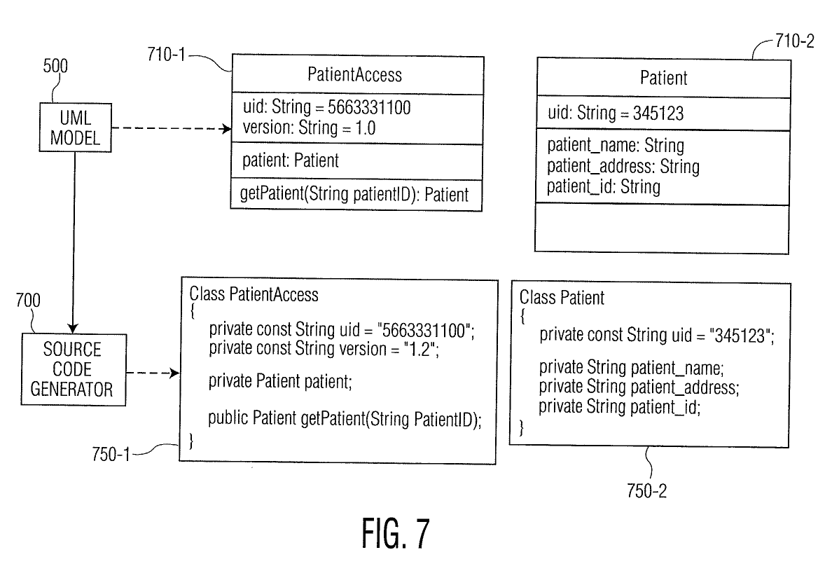

Once a UML model is built using the UML model template 500 in accordance with the present invention, XML schemas and source code in a given programming language can be automatically generated using existing tools together with additional mapping rules as illustrated in FIGS. 6 and 7.

FIG. 6 illustrates an XML schema generator 600 that generates XML schemas 650 using the UML model template 500. The XML schema generator 600 may be embodied, for example, as a computer or workstation that employs the XML Metadata Interchange (XMI) toolkit, commercially available from IBM Corp. and described in http://www.alphaworks.ibm.com/tech/xmiframework, or similar tools, such as the HyperModel™ application commercially available from XMLModeling Corp. and described in www.xmlmodeling.com, as modified herein to incorporate the modified notation/template of the present invention, as would be apparent to a person of ordinary skill in the art.

In one exemplary embodiment, the XML schema generator 600 maps a UML class to an XML Schema component, such as complexType, element, or simpleType, based on its stereotype. The constant attributes are mapped to the attributes of this component. Likewise, the variable attributes are mapped to the elements of this component.

FIG. 7 illustrates a source code generator 700 that generates Java source code 750-1, 750-2, using the UML model template 500. The source code generator 700 may be embodied, for example, as a computer or workstation that employs the Rational Rose™ tool, commercially available from Rational Software Corporation and described in http://www.rational.com, or similar tools, such as System Architect™ from Popkin Software Corporation, and described in www.popkin.com, as modified herein to incorporate the modified notation/template of the present invention, as would be apparent to a person of ordinary skill in the art.

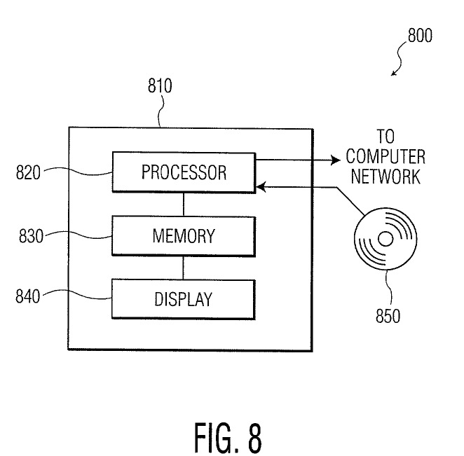

Referring now to FIG. 8, a block diagram is shown of an exemplary system 800 suitable for carrying out embodiments of the present invention. System 800 could be used for some or all of the methods and systems disclosed in FIGS. 5 through 7. System 800 comprises a computer system 810 and a Compact Disk (CD) 850. Computer system 810 comprises a processor 820, a memory 830 and a video display 840.

As is known in the art, the methods and apparatus discussed herein may be distributed as an article of manufacture that itself comprises a computer-readable medium having computer-readable code means embodied thereon. The computer-readable program code means is operable, in conjunction with a computer system such as computer system 810, to carry out all or some of the steps to perform the methods or create the apparatuses discussed herein. The computer-readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk, such as compact disk 850.

Memory 830 configures the processor 820 to implement the methods, steps, and functions disclosed herein. The memory 830 could be distributed or local and the processor 820 could be distributed or singular. The memory 830 could be implemented as an electrical, magnetic or optical memory, or any combination of these or other types of storage devices. Moreover, the term “memory” should be construed broadly enough to encompass any information able to be read from or written to an address in the addressable space accessed by processor 810. With this definition, information on a network is still within memory 830 because the processor 820 can retrieve the information from the network. It should be noted that each distributed processor that makes up processor 820 generally contains its own addressable memory space. It should also be noted that some or all of computer system 810 can be incorporated into an application-specific or general-use integrated circuit.

Video display 840 is any type of video display suitable for interacting with a human user of system 800. Generally, video display 840 is a computer monitor or other similar video display.

It is to be understood that the embodiments and variations shown and described herein are merely illustrative of the principles of this invention and that various modifications may be implemented by those skilled in the art without departing from the scope and spirit of the invention.

What is claimed is:

1. A method for representing an XML object using a UML model, comprising the steps of:
providing a UML model unit for representing said XML object, said UML model unit having a plurality of compartments; and
providing separate compartments in said UML model unit for representing constant and variable attributes of said XML object.

2. The method of claim 1, wherein said constant attribute compartment stores attributes that remain constant through all instances of an object.

3. The method of claim 1, wherein said variable attribute compartment stores attributes that vary for different instances of an object.

4. The method of claim 1, wherein said constant attributes are automatically mapped to attributes of an XML Schema component.

5. The method of claim 1, wherein said variable attributes are automatically mapped to elements of an XML Schema component.

6. A method for generating an XML schema from a UML model, comprising the steps of:
modeling said XML schema using an extended UML model unit having separate compartments for representing constant and variable attributes of said XML object; and
automatically generating said XML schema from said modeled XML schema.

7. The method of claim 6, wherein said step of automatically generating said XML schema further comprises the step of mapping constant attributes to attributes of an XML Schema component.

8. The method of claim 6, wherein said step of automatically generating said XML schema further comprises the step of mapping variable attributes to elements of an XML Schema component.

9. A method for generating source code from a UML model, comprising the steps of:
modeling said source code using an extended UML model unit having separate compartments for representing constant and variable attributes of said XML object; and
automatically generating said source code from said modeled XML schema.

10. The method of claim 9, wherein said step of automatically generating said source code further comprises the step of mapping constant attributes to constant member variables of a class.

11. The method of claim 9, wherein said step of automatically generating said source code further comprises the step of mapping variable attributes to member variables other than constant variables of a class.

12. A system for representing an XML object using a UML model, comprising:
a memory for storing computer readable code; and
a processor operatively coupled to said memory, said processor configured to:
provide a UML model unit for representing said XML object, said UML model unit having a plurality of compartments; and
provide separate compartments in said UML model unit for representing constant and variable attributes of said XML object.

13. The system of claim 12, wherein said constant attribute compartment stores attributes that remain constant through all instances of an object.

14. The system of claim 12, wherein said variable attribute compartment stores attributes that vary for different instances of an object.

15. The system of claim 12, wherein said constant attributes are automatically mapped to attributes of an XML Schema component.

16. The system of claim 12, wherein said variable attributes are automatically mapped to elements of an XML Schema component.

17. A system for generating an XML schema from a UML model, comprising:
a memory for storing computer readable code; and
a processor operatively coupled to said memory, said processor configured to:
model said XML schema using an extended UML model unit having separate compartments for representing constant and variable attributes of said XML object; and
automatically generate said XML schema from said modeled XML schema.

18. A system for generating source code from a UML model, comprising:
a memory for storing computer readable code; and
a processor operatively coupled to said memory, said processor configured to:
model said XML schema using an extended UML model unit having separate compartments for representing constant and variable attributes of said XML object; and
automatically generate said source code from said modeled XML schema.

19. An article of manufacture for representing an XML object using a UML model, comprising:
a computer readable medium having computer readable code means embodied thereon, said computer readable program code means comprising:
a step to provide a UML model unit for representing said XML object, said UML model unit having a plurality of compartments; and
a step to provide separate compartments in said UML model unit for representing constant and variable attributes of said XML object.

20. The article of manufacture of claim 19, further comprising a step to automatically generate an XML schema from said modeled XML schema.

21. The article of manufacture of claim 19, further comprising a step to automatically generate source code from said modeled XML schema.
